(19) United States
(12) Patent Application Publication
(10) Pub. No.: US 2026/0040035 A1
(43) Pub. Date: Feb. 5, 2026

(54) METHODS AND APPARATUS FOR INTEGRATION OF 3GPP MULTICAST/BROADCAST SERVICES FOR 5G AND IEEE 802.11bc

(71) Applicant: InterDigital Patent Holdings, Inc., Wilmington, DE (US)

(72) Inventors: Antonio de la Oliva, Madrid (ES); Robert Gazda, Spring City, PA (US); Ulises Olvera-Hernandez, Saint-Lazare (CA); Michael Starsinic, Newtown, PA (US); Chonggang Wang, Princeton, NJ (US)

(21) Appl. No.: 18/997,722

(22) PCT Filed: Jul. 25, 2023
(86) PCT No.: PCT/US2023/028554

§ 371 Date: Jan. 22, 2025

Related U.S. Application Data
(60) Provisional application No. 63/392,809, filed on Jul. 27, 2022.

(51) Int. Cl. H04W 4/06; H04W 28/02; H04W 72/30; H04W 84/12

(52) U.S. Cl. CPC H04W 4/06; H04W 28/0268; H04W 72/30; H04W 84/12

(57) ABSTRACT

Methods and apparatus for delivering 5G multicast/broadcast services to WTRUs in a 3GPP network via non-3GPP access, such as 802.11bc Enhanced Broadcast Service networks, are described. One method may include receiving, from the 3GPP network, first information indicating a service announcement or a protocol data unit (PDU) session request associated with 3GPP multicast/broadcast services (MBS. The first information may include MBS session information. The method may further include determining, based on the MBS session information, a MBS session context in the wireless LAN. The MBS session context may include second information used for transmission of the MBS over the wireless LAN. The method may then include transmitting third information indicating the MBS session context to the wireless LAN for distribution to Wireless Transmit Units (WTRUs) in the wireless LAN.

### CROSS-REFERENCE TO RELATED APPLICATIONS

This application claims the benefit of U.S. Provisional Application No. 63/392,809 filed Jul. 27, 2022, the contents of which are incorporated herein by reference in their entirety.

### FIELD

This disclosure may pertain, for example, to methods and apparatus for delivering 5G multicast/broadcast services to WTRUs in a 3GPP network via non-3GPP access, such as 802.11bc Enhanced Broadcast Service networks.

### SUMMARY

An embodiment may include a method for interfacing between a 3GPP network and a wireless local area network (LAN). The method may include receiving, from the 3GPP network, first information indicating a service announcement or a protocol data unit (PDU) session request associated with 3GPP multicast/broadcast services (MBS). The first information may include or may indicate MBS session information. The method may include determining, based on the MBS session information, a MBS session context in the wireless LAN, where the MBS session context may include second information used for transmission of the MBS over the wireless LAN. The method may also include transmitting third information that indicates the MBS session context to the wireless LAN for distribution to Wireless Transmit Units (WTRUs) in the wireless LAN.

An embodiment may include an apparatus configured to interface between a 3GPP network and a wireless local area network (LAN). The apparatus may include circuitry including any one or more of a processor, memory, transmitter and/or receiver. The circuitry may be configured to receive, from the 3GPP network, first information indicating a service announcement or a protocol data unit (PDU) session request associated with 3GPP multicast/broadcast services (MBS). The first information may include or may indicate MBS session information. The circuitry may also be configured to determine, based on the MBS session information, a MBS session context in the wireless LAN. The MBS session context may include second information used for transmission of the MBS over the wireless LAN. The circuitry may be configured to transmit third information indicating the MBS session context to the wireless LAN for distribution to Wireless Transmit Units (WTRUs) in the wireless LAN.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGs.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a block diagram illustrating the system architecture for Multicast and Broadcast Service;

FIG. 3 is a block diagram of the interconnectivity architecture in 3GPP for an untrusted non-3GPP network;

FIG. 4 is a block diagram of the interconnectivity architecture in 3GPP for a trusted non-3GPP network;

FIG. 5 is a block diagram of an integrated MBS/EBCS architecture in accordance with an embodiment;

FIG. 6 is a signal flow diagram illustrating the setup of the session on the 3GPP side in accordance with an embodiment;

FIG. 7 is a signal flow diagram illustrating an ATSSS procedure in accordance with an embodiment;

FIG. 8 is a signal flow diagram illustrating a process for advertisement of MBS services of non-3GPP access in accordance with an embodiment;

FIG. 9 is a signal flow diagram of the starting of a multicast service requiring request from the IEEE 802.11bc side in accordance with an embodiment; and

FIG. 10 is a flow diagram of a method, according to an embodiment.

### DETAILED DESCRIPTION

### Introduction

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

### Example Communication Systems

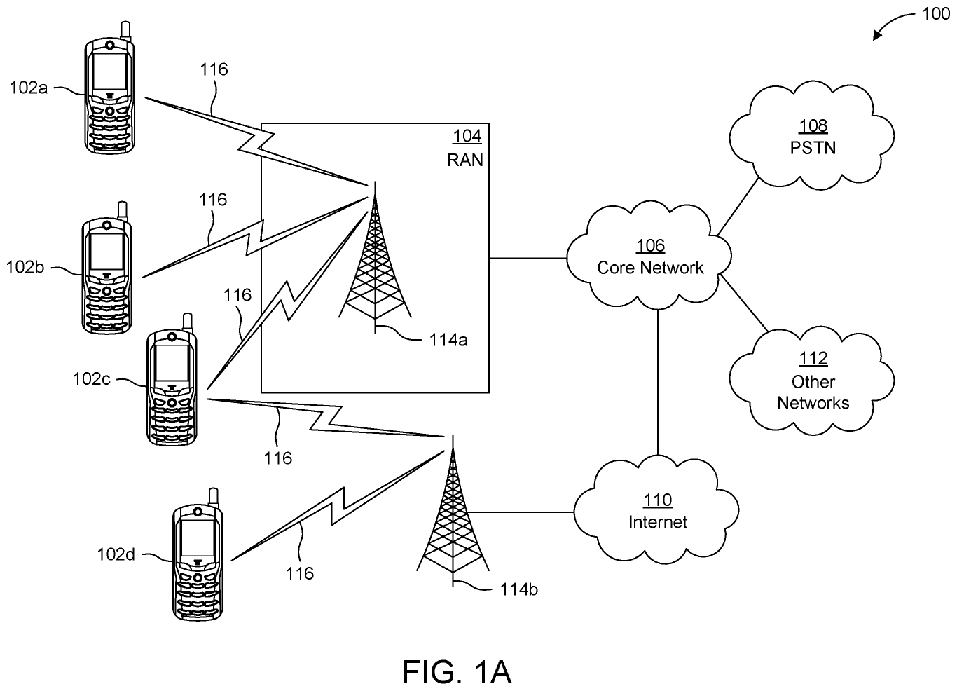

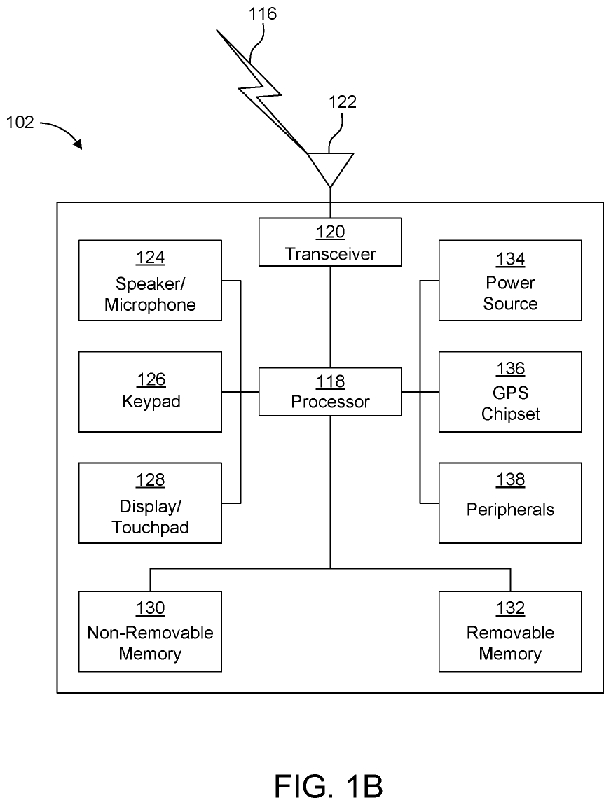

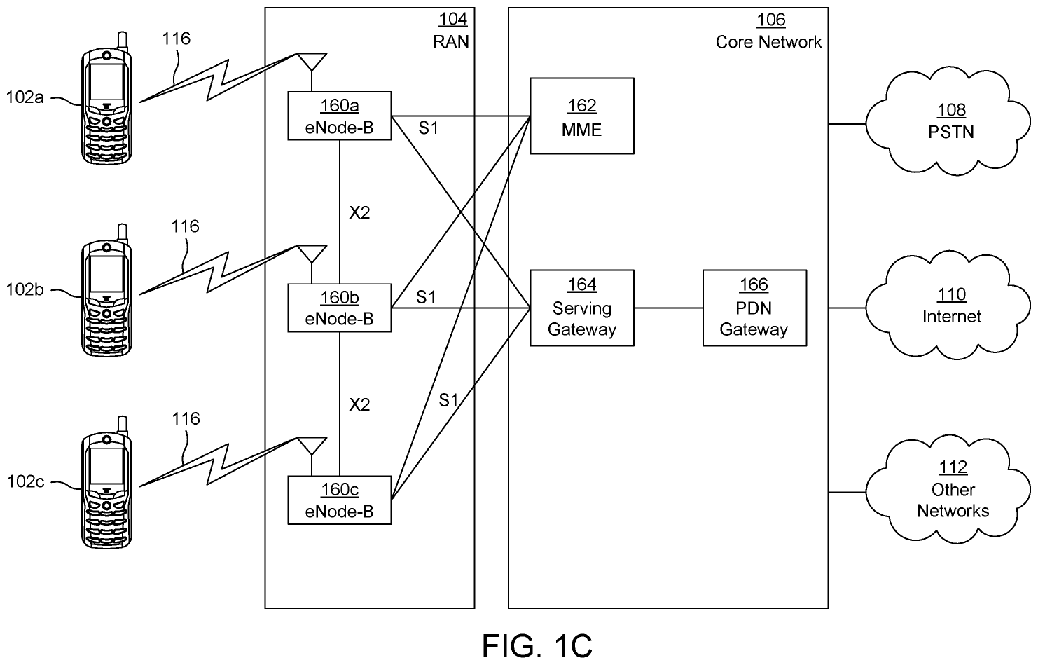

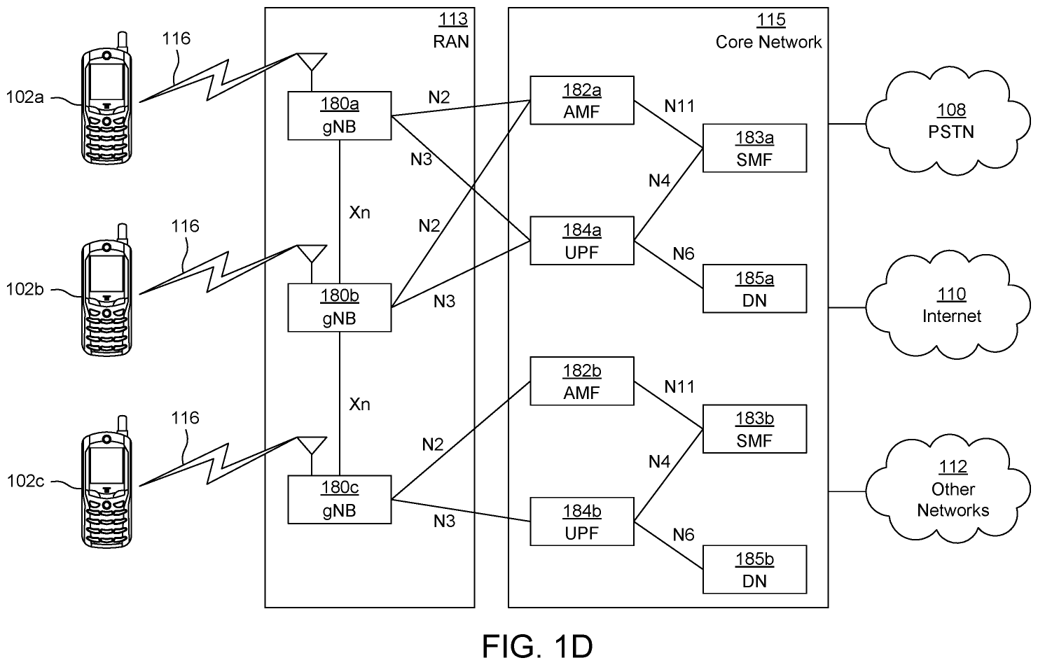

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WIMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHz, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHz, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the uplink (UL) and/or downlink (DL), support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF a82a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Multicast/Broadcast Environment

### IEEE 802.11bc

IEEE 802.11bc specifies modifications to the IEEE 802.11 medium access control (MAC) specifications that enable enhanced transmission and reception of broadcast data both in an infrastructure Basic Service Set (BSS) where there is an association between the transmitter and the receiver(s) and in cases where there is no association between transmitter(s) and receiver(s).

Multiple use cases for IEEE 802.11bc have been described in [1], including: Stadium Video Distribution, Low Power Sensor UL Broadcast, Intelligent Transportation Broadcast, Broadcast Services for Event Production, Multi-lingual and Emergency Broadcast, VR eSports Video Distribution, Multi-channel Data Distribution, Lecture room slide distribution, Regional-based broadcast TV service, and AP tagged Uplink (UL) forwarding.

Stadium Video Distribution may include providing Enhanced Broadcast Services (EBCS) for videos to a large number of densely located Stations (STAs). These STAs may be associated, or unassociated with the Access Point (AP) or may be STAs that do not transmit.

Low Power Sensor UL Broadcast may include that pre-configured Internet of Things (IoT) devices automatically connect to the end server through EBCS Access Points (APs) with zero setup action required. This functionality includes low power IoT devices in mobility reporting to their servers through EBCS APs without scanning and association.

Intelligent Transportation Broadcast may include Connected Vehicle Roadside Equipment (RSE), Connected Vehicle On Board Equipment (OBE) and Personal Informational Device (PID) provide EBCS service for transportation related information for railway crossing or RSE provides EBCS service for local traveler information.

Broadcast Services for Event Production may include providing EBCS for multiple data streams suitable for different customer STAs. The number of STAs may be large and these STAs may be stationary or mobile.

Multi-lingual and Emergency Broadcast may include providing EBCS for emergency and/or Multi-lingual service to a large number of densely located STAs. These STAs may be associated or unassociated with the AP, or may be STAs that do not transmit. These STAs may be stationary or mobile.

VR eSports Video Distribution may include, at the location of Virtual Reality (VR) eSports games, such as an arena, EBCS distributes the video that is the view of the player to the audiences.

Multi-channel Data Distribution may include that an AP broadcasts the same information in different languages, each in a dedicated channel. A user can choose one of the channels.

Lecture room slide distribution may include simultaneous distribution of slides on the screen to audience PC, Tablet, etc. The audience members do no need to download visual aids and change pages. Slide distribution to all students is synchronized.

Regional-based broadcast TV service may include that TV content, such as local news, can be distributed to consumer Bring Your Own Device (BYOD) devices (not TV receiver) by a small local TV company. In case of disaster, evacuation information may be distributed without any complex customer operation.

AP tagged Uplink (UL) forwarding may include that a pre-configured low-cost, low power tracker device automatically connects to an end server through EBCS APs in the neighborhood with zero setup action. A tracker device periodically reports to its server through EBCS APs without scanning and association. Tracker periodically broadcasts UL frames which are opportunistically received at EBCS APs. EBCS AP appends metadata (such as IP, date/time, location, RSSI etc.) to the packets before forwarding to the destination server. Meta-data from an EBCS AP will be protected.

### 5G Multicast/Broadcast Services (MBS)

Multicast and Broadcast Service (MBS) is a point-to-multipoint service in which data is transmitted from a single source entity to multiple recipients, either to all users in a broadcast service area, or to users in a multicast group. MBS services include broadcast services, where the content is broadcasted without requiring a request from a WTRU, and multicast, requiring the request from a WTRU.

The MBS specifies RAN enhancements for the efficient usage of the radio interface and CN enhancements for the efficient distribution of the content to the RAN, via multicast and broadcast services. Between 5GC and NG-RAN, there are two possible delivery methods to transmit the MBS data: 5GC individual MBS traffic delivery method, and 5GC shared MBS traffic delivery method.

The 5GC individual MBS traffic delivery method may be applied just for a multicast MBS session. For example, 5GC receives a single copy of MBS data packets and delivers separate copies of those MBS data packets to individual WTRUs via per-WTRU PDU sessions. Hence, for each such WTRU, one PDU session is required to be associated with a multicast session.

The 5GC Shared MBS traffic delivery method may be applied for both broadcast and multicast MBS sessions. For example, the 5GC receives a single copy of MBS data packets and delivers a single copy of those MBS packets to a 5G RAN node, which then delivers the packets to one or multiple WTRUs.

The 5G MBS also provides functionalities such as local MBS service, authorization of multicast MBS and QoS differentiation.

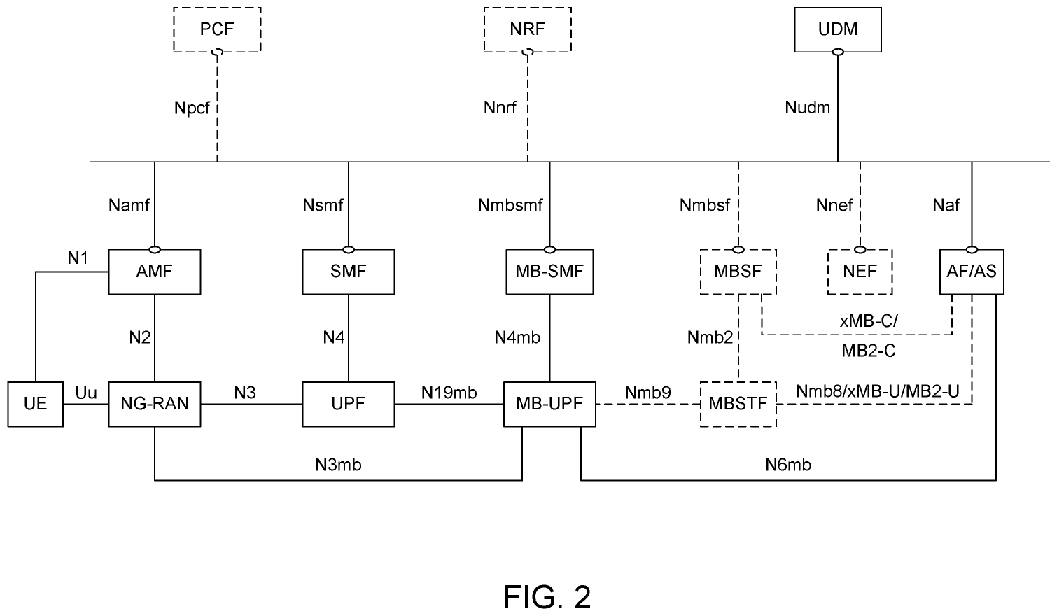

The architecture of the MBS is defined in TS23.247 (v17.0.0) and shown in FIG. 2.

The MBS architecture enhances the 5GS architecture through the introduction of several new functionalities or entities (among others not included in this disclosure), such as: Multicast/Broadcast Session Management Function (MB-SMF), Multicast/Broadcast User Plane Function (MB-UPF), Network Exposure Function (NEF), Multicast/Broadcast Service Function (MBSF), Multicast/Broadcast Service Transport Function (MBSTF).

The MB-SMF supports the MBS session management, configures the MB-UPF (Multicast/Broadcast User Plane Function) for multicast and broadcast transport flows, allocates and de-allocates TGMIs (Temporary Mobile Group Identities) used to identify the MBS flows, and interacts with the RAN through the AMF to control data transport.

The MB-UPF performs packet filtering for the downlink packets for multicast and broadcast, QoS enforcement, delivery of multicast and broadcast data to the RAN based on the chosen transport method, and interaction with MB-SMF for receiving multicast and broadcast traffic.

The NEF provides an interface to Application Functions (Afs) for MBS procedures including service provisioning, MBS session, and QoS Management.

The MBSF provides service level functionality to support MBS, and interworking with LTE MBMS (Multimedia Broadcast/Multicast Service), interacting with access function (AF) and MB-SMF for MBS session operations, determination of transport parameters, and session transport. It also performs selection of MB-SMF to serve an MBS Session and controls the Multicast/Broadcast Service Transport Function (MBSTF) if the MBSTF is used.

The MBSTF may be a media anchor for MBS data traffic if needed, including sourcing of IP multicast if needed, generic packet transport functionalities available to any IP multicast enabled application such as framing, multiple flows, packet FEC (encoding), and multicast/broadcast delivery of input files as objects or object flows.

Interconnection of 5GS with Non-3GPP RAN Technologies

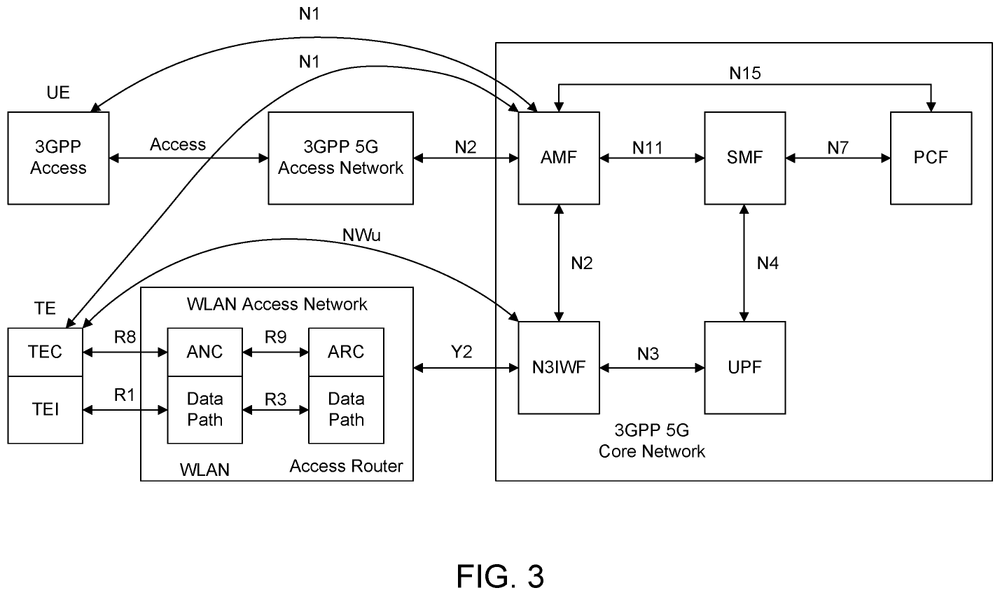

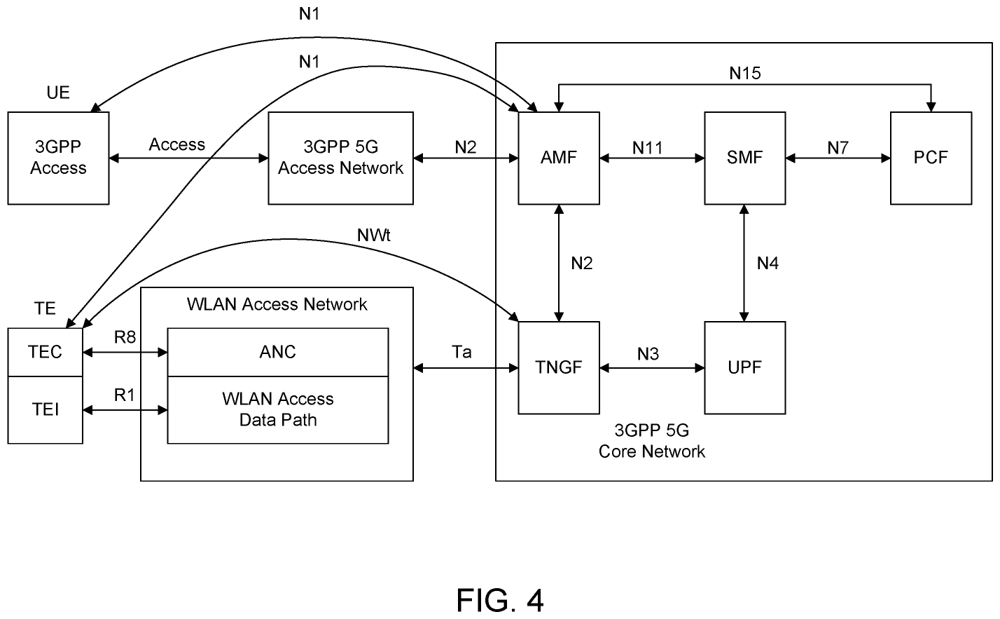

3GPP has defined different architectures enabling the interconnection of non-3GPP networks, such as IEEE 802.11, to the 5GS. These architectures are defined in 3GPP TS 23.502 and 3GPP TS 24.502. 3GPP defines two different connectivity scenarios, considering if the non-3GPP network is trusted, e.g., is administratively controlled by the 3GPP network, or un-trusted. For untrusted non-3GPP access network, it will be connected to the 5G Core Network via a Non-3GPP InterWorking Function (N3IWF), whereas a trusted non-3GPP access network will be connected to the 5G Core Network via a Trusted Non-3GPP Gateway Function (TNGF). Both the N3IWF and the TNGF interface with the 5G Core Network Control Plane (CP) and User Plane (UP) functions via the N2 and N3 interfaces, respectively, as shown in FIGS. 3 and 4, taken from [3].

Both trusted and untrusted connectivity scenarios secure the data of the Terminal (TE) through an IPsec tunnel between the TE and the N3IWF/TNGF, although the setting of the IPsec tunnel will use different mechanisms on each scenario. Consistent with [3], TE indicates a Terminal connected to 3GPP via WiFi access. However, WTRU and TE are both WTRU devices and are interchangeable.

One of the key challenges faced when integrating IEEE 802.11bc (hereinafter EBCS) and MBS architecture is that the two broadcasting mechanisms are designed from different points of view.

The 3GPP MBS system is designed so that an authorized Application Server/Application Function (AS/AF) may be able to broadcast/multicast content directly in the 3GPP network. For example, an AS is able to directly advertise broadcast/multicast services by direct WTRU signaling via standard Internet Engineering Task Force (IETF) protocols, such as Session Description Protocol (SDP). Therefore, there is no service advertisement mechanism frame that is used to advertise all MBS services available in a certain area. Each service is advertised and distributed independently.

On the other hand, EBCS is based on pre-authorization of services to be transmitted over the ESS (Extended Service Set). Services are registered in the EBCS ESS and advertised jointly in IEEE common 802.11bc service advertisement frames. Therefore, direct and independent signaling of available services by the transmitting server is not allowed. In fact, while in 3GPP, the service transmitter must be authorized to use MBS, in EBCS, the service must be authorized to be transmitted by pre-registering it.

This creates a complex challenge to deliver MBS services offered in the 3GPP system via EBCS domains, connected to the 3GPP system in trusted and un-trusted non-3GPP interconnectivity architectures.

### Architectures, Methods, and Apparatus for Integration of 5G and Non-3GPP Delivery of Multicast/Broadcast Services

In accordance with some example embodiments, 3GPP MSB-IEEE 802.11bc architectures, modified context structures, and message sequence diagrams are presented herein for integrating a WLAN, such as IEEE 802.11bc, in a 3GPP 5G MBS network for providing multicast/broadcast services.

In various embodiments, a new MBS/EBCS Controller entity is provided that: 1) marshals/advertises 3GPP MBS service advertisements via 802.11bc to terminals connected by WiFi (trusted or untrusted); and/or 2) triggers multi-cast streams from the MBS AF/AS based on EBSC requests from terminals connected by WiFi (trusted or untrusted).

According to certain example embodiments, a new module is provided within the trusted and untrusted WLAN-to-3GPP interconnectivity architecture. The new element, herein termed MBS_EBCS_Controller, may reside in the N3IWF or TNGF and may populate the EBCS filters within the IEEE 802.11 network and behaves as a WTRU in order to request MBS services.

In various embodiments, extension are provided to ATSSS steering modes and 5GS session management (5GSM) information elements to indicate the new ATSSS steering mode.

In various embodiments, extensions are provided to the MBS Session Context including the information needed for the transmission of an MBS service over IEEE 802.11bc.

In various embodiments, extensions are provided to the message sequence diagrams showing how a broadcast and a multicast MBS session using IEEE 802.11bc as the RAN for the case of ATSSS support (for multicast streams) and for the case of without ATSSS support (broadcast and multicast).

### Integrated Architecture MBS-IEEE 802.11bc

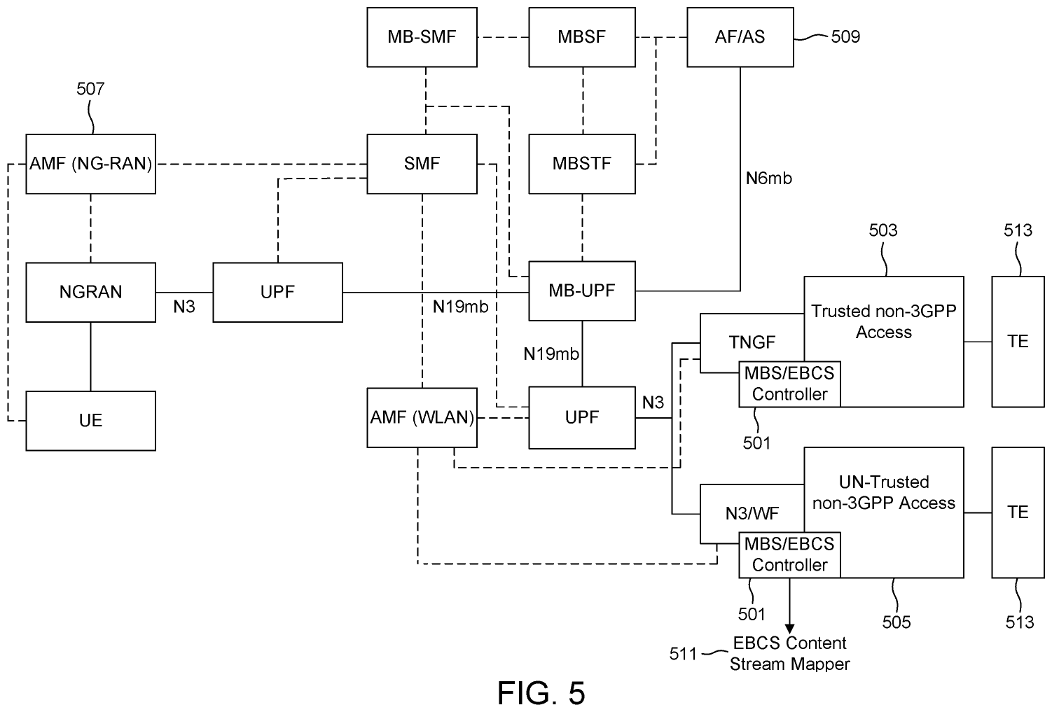

FIG. 5 is a block diagram of an integrated MBS/EBCS architecture in accordance with an embodiment, wherein dashed lines correspond to control interfaces while solid lines correspond to the data plane interfaces.

The key element introduced in this architecture is the MBS/EBCS Controller entity (from now on MBS_EBCS_Controller 501). This entity may be collocated in the TNGF, in the N3IWF or may be separated. In the example embodiment shown in FIG. 5, there is one MBS_EBCS_Controller 501a associated with a trusted non-3GPP access network 503 and one MBS_EBCS_Controller 501b associated with an untrusted non-3GPP access network 505. Its primary functionality may be twofold. The MBS_EBCS_Controller 501 may listen to service advertisement from the AF/AS 509 and configures the EBCS Content Stream Mapper 511 (or any other IEEE 802.11bc element in charge of advertisement of EBCS services and filtering of ingress EBCS traffic streams) of the IEEE 802.11bc domain, registering the 5G MBS services in the network so they can be advertised to terminals on WiFi access via 802.11bc. In case of multicast transmission, the MBS_EBCS_Controller 501 may receive a trigger from the EBCS domain when a TE 513 issues an EBCS message requesting the start of a multicast stream (for example, an Enhanced Broadcast Services Request Access Network Query Protocol (ANQP)-element as per IEEE 802.11bc/D2.0). The MBS_EBCS_Controller 501 performs the N1/higher layer signaling required to request the multicast stream at the 3GPP side on behalf of WTRUs working as TEs in the IEEE 802.11bc domain. In case N1 signaling is needed, this part of the MBS_EBCS_Controller functionality resides at the N1 stack at the TE.

MBS Sessions are defined by an MBS Session Context, which is stored in every node that processes an MBS traffic stream. This MBS Session Context is defined in 3GPP TS 23.247 and may be modified as shown below in Table 1 below to consider the MBS_EBCS_Controller 501 for the case of Broadcast MBS. In the Tables below, the new parameters are indicated by underlining. Furthermore, an X in a column of the table means the MBS Session Context stored at each of the entities as per the column header includes the element in the row.

TABLE 1
Modification to Table 6.9.1-2: Broadcast MBS Session
context (3GPP TS 23.247 V17.0.0 2021-09)

| | | NG- | | MB- | MBS EBCS |
|---|---|---|---|---|---|
| Parameter | Description | RAN | AMF | SMF | Controller |
| TMGI | Temporary Mobile Group | X | X | X | X |
| | Identity allocated to the MBS | | | | |
| | Session. | | | | |
| Area Session | Used for MBS session with | X | X | X | X |
| Identifier | location dependent content. | | | | |
| | When present, the Area | | | | |
| | Session Identifier together | | | | |
| | with the TMGI uniquely | | | | |
| | identify the MBS Session in | | | | |
| | a specific MBS service area. | | | | |
| AMF | The AMF(s) which are | X | | X | X |
| | selected for the MBS | | | | |
| | session | | | | |
| QoS | QoS information for the MBS | X | | X | X |
| Information | Session, including the QoS | | | | |
| | parameters of QoS flows. | | | | |
| MBS Service | Area over which the MBS | X | X | X | X |
| Area | session data is distributed | | | | |
| | (i.e., Cell ID list or TAI list, or | | | | |
| | list of IEEE 802.11 | | | | |
| | networks). | | | | |
| NG-RAN | NG-RAN nodes which are | | X | | |
| Node ID(s) | selected for the broadcast | | | | |
| | session | | | | |
| IP multicast | IP addresses identifying the | X | | X | X |
| address for | user plane transport used for | | | | |
| data | shared delivery between | | | | |
| distribution | MB-UPF and NG-RAN when | | | | |
| | the IP multicast transport is | | | | |
| | used. | | | | |
| NG-RAN IP | The IP address of NG-RAN | X | | X | |
| Address for | used for the user plane | | | | |
| data | between NG-RAN and MB- | | | | |
| distribution | UPF when Point to Point | | | | |
| | tunnel is used. | | | | |
| TEID for data | The tunnel ID used for | X | | X | X |
| distribution | receiving the broadcast data | | | | |
| | for shared delivery by NG- | | | | |
| | RAN | | | | |
| MB-PCF | The MB-PCF that provides | | | X | |
| | policy control for the MBS | | | | |
| | session. | | | | |
| EBCS State | State of the EBCS | | | | X |
| | transmission, it may take the | | | | |
| | values: Configured and | | | | |
| | Transmitted. | | | | |
| | See Note 2. | | | | |
| Content ID | EBCS Content ID assigned | | | | X |
| | for the given MBS traffic in | | | | |
| | the IEEE 802.11bc network. | | | | |
| Related | Content IDs of EBCS | | | | X |
| Content IDs | streams related to this MBS | | | | |
| | stream. See Note 1 | | | | |
| List of AP IDs | IDs of the APs where the | | | | X |
| where the | content may be broadcasted | | | | |
| content is | | | | | |
| broadcasted | | | | | |
| EBCS | Indication of the Content | | | | X |
| authentication | Authentication algorithm | | | | |
| algorithm | employed in this EBCS | | | | |
| | traffic stream. The values of | | | | |
| | this field may follow Table | | | | |
| | 9.397c - Content | | | | |
| | Authentication Algorithm | | | | |
| | field of IEEE 802.11bc/D2.0 | | | | |
| Next Tx | Time of the next | | | | X |
| schedule | transmission of the MBS | | | | |
| | service. | | | | |
| Proto and port | Protocol and Port used for | | | | X |
| | the transmission of the MBS | | | | |
| | service. This field may | | | | |
| | follow the values of Table 9- | | | | |
| | 397e-Destination Address | | | | |
| | type subfield encoding of | | | | |
| | IEEE 802.11bc/D2.0. | | | | |
| Title | This field may include a | | | | X |
| | human readable description | | | | |
| | of the EBCS Content | | | | |
| Negotiation | This field may follow values | | | | X |
| method | of Table 9.397d - Request | | | | |
| | Method subfield encoding of | | | | |
| | IEEE 802.11bc/D2.0 | | | | |
| Association | This field indicates if the | | | | X |
| Required | broadcasted EBCS requires | | | | |
| | of association to the IEEE | | | | |
| | 802.11bc AP. | | | | |
| IEEE 802.11 | QoS required by the EBCS | | | | X |
| QoS | service to be able to match | | | | |
| Information | the MBS QoS needs | | | | |

Note that an MBS traffic stream may be composed of multiple data streams, for example, audio and video in separated data frames. IEEE 802.11bc considers each of these data streams (video and audio of the same content) as different EBCS services. The MBS_EBCS_Controller 501 may create multiple EBCS traffic streams out of a single MBS service.

Also note that the MBS Context created at the MBS_EBCS_Controller 501 is in the “Configured” state when the MBS_EBCS_Controller has received the service advertisement from the AF generating the stream, but the traffic has not yet started arriving at the MBS_EBCS_Controller. Configured state indicates that the configuration is done at the MBS_EBCS_Controller. However, this configuration may have not yet been pushed into the IEEE 802.11bc domain. The “Transmitted” state indicates a request from at least one STA has been received and the MBS content is being transmitted over the air to one or more STAs as an EBCS service(s) in the 802.11bc network (or in case of broadcast without requiring request).

For the case of a multicast MBS, the MBS Session Context may be modified as shown in Table 3 below.

TABLE 2
Modification to Table 6.9.1-1: Multicast MBS Session
context (3GPP TS 23.247 V17.0.0 2021-09)

| | | NG- | MB- | | | MBS EBCS |
|---|---|---|---|---|---|---|
| Parameter | Description | RAN | SMF | SMF | AMF | Controller |
| State | State of MBS session | X | X | X | | X |
| | (‘Active multicast | | | | | |
| | session’ or ‘Inactive | | | | | |
| | multicast session’ or | | | | | |
| | ‘Configured multicast | | | | | |
| | session’) | | | | | |
| SSM (source | IP multicast address | | X | X | | X |
| specific IP | identifying the MBS | | | | | |
| multicast | session. | | | | | |
| address) | | | | | | |
| TMGI | Temporary Mobile | X | X | X | X | X |
| | Group Identity allocated | | | | | |
| | to the MBS Session. | | | | | |
| Area Session | Used for MBS session | X | X | X | X | X |
| Identifier | with location dependent | | | | | |
| | content. When present, | | | | | |
| | the Area Session | | | | | |
| | Identifier together with | | | | | |
| | the TMGI uniquely | | | | | |
| | identify the MBS | | | | | |
| | Session in a specific | | | | | |
| | MBS service area. | | | | | |
| MB-SMF | The MB-SMF that | X | | X | X | X |
| | handles the MBS | | | | | |
| | session. | | | | | |
| QoS | QoS information for the | X | X | X | | X |
| Information | MBS Session, including | | | | | |
| | the QoS parameters of | | | | | |
| | QoS flows. | | | | | |
| MBS Service | Area over which the | X | X | X | X | X |
| Area | MBS session data is | | | | | |
| | distributed (i.e. Cell ID | | | | | |
| | list or TAI list, or list of | | | | | |
| | IEEE 802.11 networks). | | | | | |
| NG-RAN | NG-RAN nodes which | | | | X | |
| Node ID(s) | are selected for the | | | | | |
| | broadcast session | | | | | |
| AMF | The AMF(s) which are | X | X | | | X |
| | selected for the MBS | | | | | |
| | session | | | | | |
| IP multicast | IP addresses identifying | X | X | X | | X |
| and source | the SSM user plane | | | | | |
| address for | transport for shared | | | | | |
| data | delivery between MB- | | | | | |
| distribution | UPF and NG-RAN and | | | | | |
| | for individual delivery | | | | | |
| | between MB-UPF and | | | | | |
| | UPF when the IP | | | | | |
| | multicast transport is | | | | | |
| | used. | | | | | |
| SMF | The SMF(s) that | | X | | | X |
| | manages the | | | | | |
| | associated PDU | | | | | |
| | session | | | | | |
| UE ID | ID identifying the WTRU | X | | X | | X |
| | that successfully join | | | | | |
| | the Multicast MBS | | | | | |
| | Session. For NG-RAN it | | | | | |
| | is NGAP UE ID and for | | | | | |
| | SMF it is SUPI. | | | | | |
| | In case of a | | | | | |
| | MBS_EBCS_Controller, | | | | | |
| | this ID identifies the ID | | | | | |
| | of the WTRU within the | | | | | |
| | MBS_EBCS_Controller, | | | | | |
| | used to request for the | | | | | |
| | multicast MBS traffic | | | | | |
| IP Address | The IP addresses and | X | X | X | | X |
| for data | TEID of NG-RAN used | | | | | |
| distribution | for the user plane | | | | | |
| | between NG-RAN and | | | | | |
| | MB-UPF and between | | | | | |
| | MB-UPF and UPF when | | | | | |
| | Point to Point tunnel is | | | | | |
| | used. | | | | | |
| TEID for data | The tunnel ID used for | X | X | X | | X |
| distribution | receiving the broadcast | | | | | |
| | data for shared delivery | | | | | |
| | by NG-RAN | | | | | |
| MB-PCF | The MB-PCF that | | X | | | X |
| | provides policy control | | | | | |
| | for the MBS session. | | | | | |
| EBCS State | State of the EBCS | | | | | X |
| | transmission, it may | | | | | |
| | take the values: | | | | | |
| | Configured, Waiting | | | | | |
| | Request and | | | | | |
| | Transmitted. | | | | | |
| | See Note 2. | | | | | |
| Content ID | EBCS Content ID | | | | | X |
| | assigned for the given | | | | | |
| | MBS traffic in the IEEE | | | | | |
| | 802.11bc network. | | | | | |
| Related | Content IDs of EBCS | | | | | X |
| Content IDs | streams related to this | | | | | |
| | MBS stream. See Note | | | | | |
| | 1 | | | | | |
| List of AP IDs | IDs of the APs where | | | | | X |
| where the | the content may be | | | | | |
| content is | broadcasted | | | | | |
| broadcasted | | | | | | |
| EBCS | Indication 0 the | | | | | X |
| authentication | Content Authentication | | | | | |
| algorithm | algorithm employed in | | | | | |
| | this EBCS traffic | | | | | |
| | stream. The values of | | | | | |
| | this field may follow | | | | | |
| | Table 9.397c - Content | | | | | |
| | Authentication | | | | | |
| | Algorithm field of IEEE | | | | | |
| | 802.11bc/D2.0 | | | | | |
| Next Tx | Time of the next | | | | | X |
| schedule | transmission of the | | | | | |
| | MBS service. | | | | | |
| Proto and port | Protocol and Port used | | | | | X |
| | for the transmission of | | | | | |
| | the MBS service. This | | | | | |
| | field may follow the | | | | | |
| | values of Table 9-397e- | | | | | |
| | Destination Address | | | | | |
| | type subfield encoding | | | | | |
| | of IEEE 802.11bc/D2.0. | | | | | |
| Title | This field may include a | | | | | X |
| | human readable | | | | | |
| | description of the EBCS | | | | | |
| | Content | | | | | |
| Negotiation | This field may follow | | | | | X |
| method | values of Table 9.397d - | | | | | |
| | Request Method | | | | | |
| | subfield encoding of | | | | | |
| | IEEE 802.11bc/D2.0 | | | | | |
| Association | This field indicates if the | | | | | X |
| Required | broadcasted EBCS | | | | | |
| | requires of association | | | | | |
| | to the IEEE 802.11bc | | | | | |
| | AP. | | | | | |
| IEEE 802.11 | QoS required by the | | | | | X |
| QoS | EBCS service to be able | | | | | |
| Information | to match the MBS QoS | | | | | |
| | needs | | | | | |

Note that an MBS traffic stream may be composed of multiple data streams, for example, audio and video in separated data frames. IEEE 802.11bc considers each of these data streams (video and audio of the same content) as different EBCS services. The MBS_EBCS_Controller 501 may create multiple EBCS traffic streams out of a single MBS service. If TMGI is used as the MBS session identifier, EBCS services may be mapped to specific TMGIs and QoS profile.

Also note that the MBS Context created at the MBS_EBCS_Controller 501 is in the “Configured” state when the MBS_EBCS_Controller has received the service advertisement, but the traffic has not yet started arriving at the MBS_EBCS_Controller. Configured state indicates the service configuration is applied at the MBS_EBCS_Controller. However, this configuration may not have been pushed into the IEEE 802.11bc domain. The “Waiting request” state indicates that the MBS Session context is available and EBCS configuration for this service is installed in the IEEE 802.11bc network (i.e., advertised and available for the TE). EBCS services in this state implies that the content requires a request message from the STAs to be transmitted. The “Transmitted” state indicates a request from at least one STA for the MBS Context has been received and the MSB content is being transmitted to one or more STAs over the air as an EBSC service(s) in the 802.11bc network (or, in case of broadcast, without requiring request).

The EBCS related parameters have been included above in MBS Session context as a possible implementation, but they may be part of this context or created separately in a different structure that is later linked to the MBS traffic received.

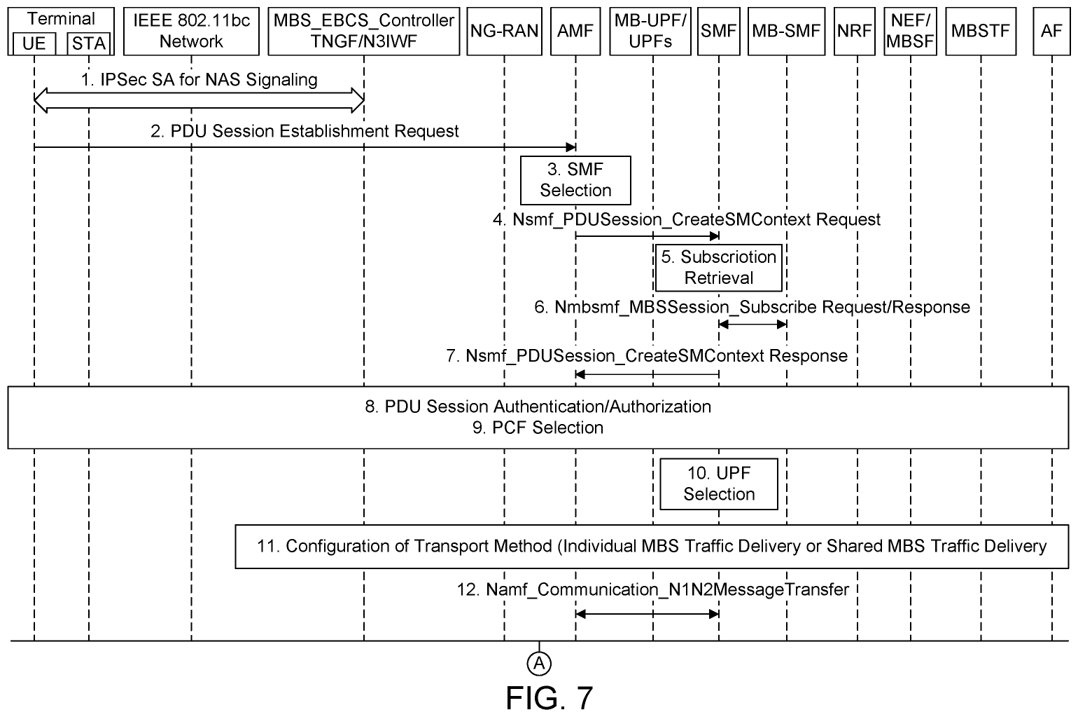

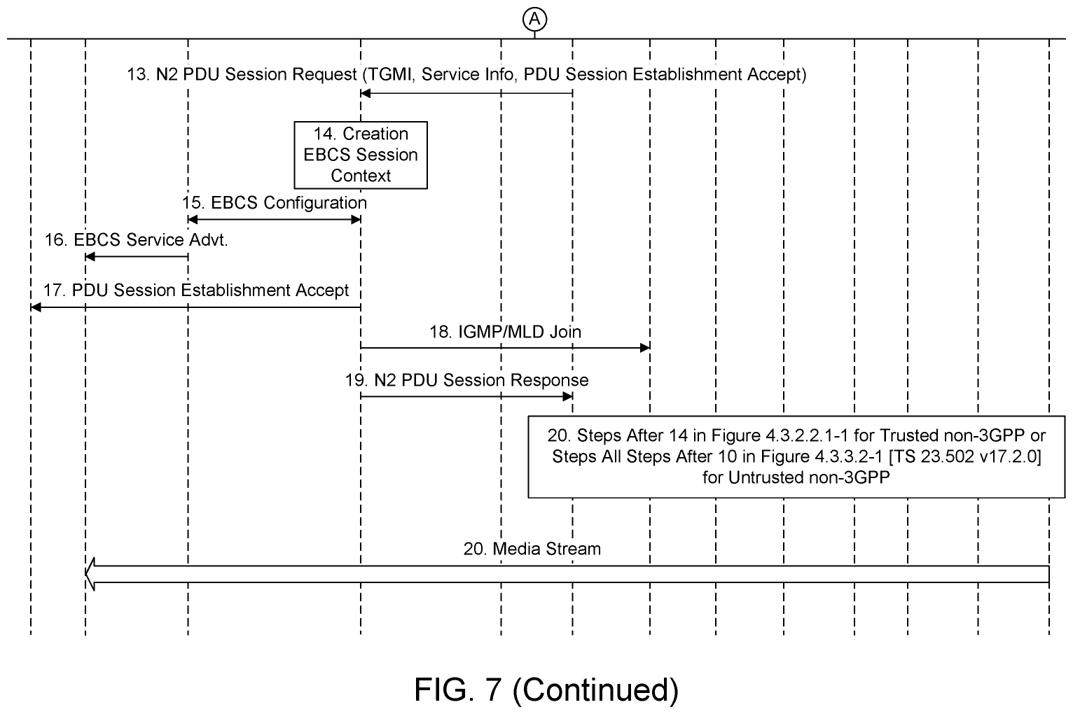

Multicast and Broadcast Services (MBS) are announced by the AF 509 providing them towards the 3GPP network. There are different protocols and mechanisms that the AF (depending on its level of authorization) may use. Example of these mechanisms include SIP/SDP based approaches or approaches based on 3GPP group mechanisms. See [11]. The information required by the MBS_EBCS_Controller 501 to create an EBCS context and start advertising the service within the EBCS network may be obtained from the inspection of the announcements sent by the AF. In addition, some other information may be obtained from the AMF 507, once the TGMI has been allocated and the context at the AMF has been created. This information is passed from the AMF 507 to the MBS_EBCS_Controller 501 through the N2 Message Request (e.g., Step 22 in FIG. 7 discussed in more detail below).

### Use of ATSS Functionality to Redirect MBS Traffic to a Non-3GPP Network Supporting IEEE 802.11bc

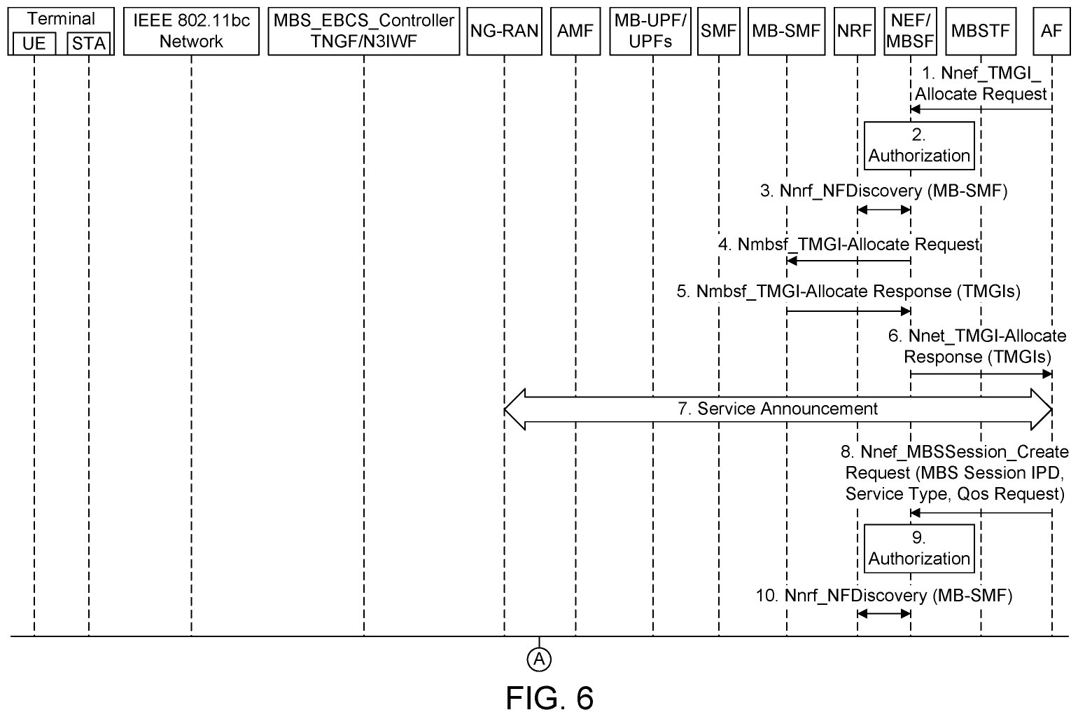

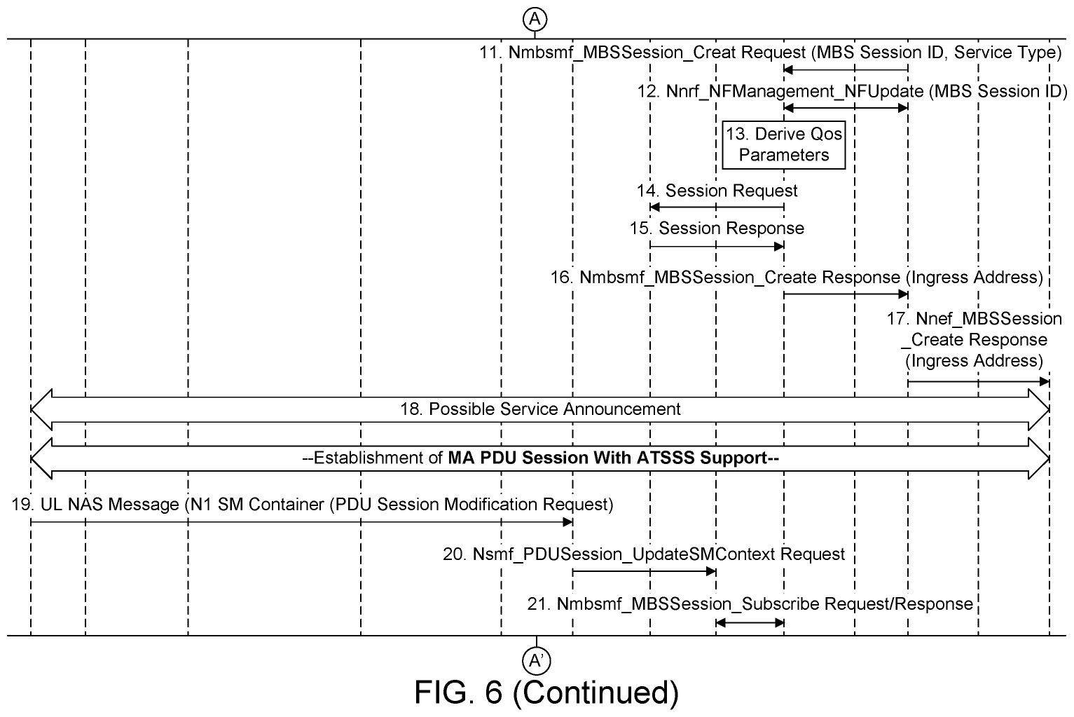

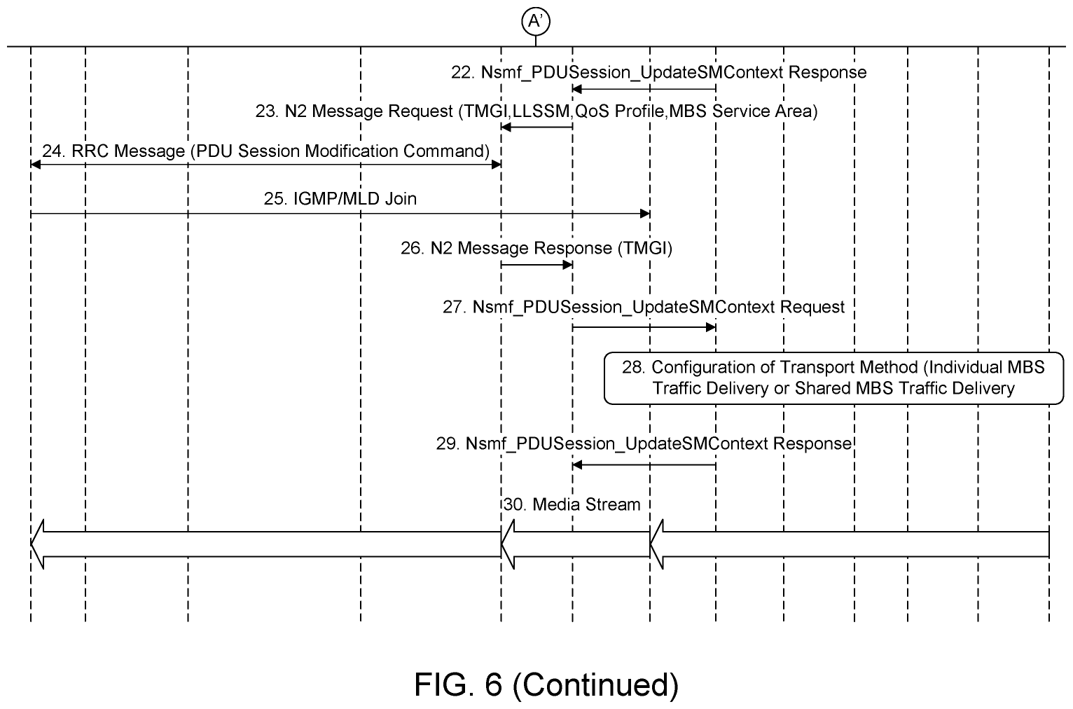

This embodiment focuses on the use of Access Traffic Steering, Switching and Splitting (ATSSS) and Multi Access (MA) PDU sessions to locally breakout an MBS session to a non-3GPP access supporting IEEE 802.11bc. The procedure starts with FIG. 6, which shows the setup of the session on the 3GPP side and the definition of the new ATSSS steering mode, while FIG. 7 completes the sequence chart for the ATSSS procedure.

The signal flow diagram of FIG. 6 assumes that the WTRU and the network may support ATSSS, and the WTRU may be associated with the same Public Land Mobile Network (PLMN) using both 3GPP and Non-3GPP accesses, although the idea may be applied to accesses connecting to different PLMNs with minor modifications.

FIG. 6 effectively is an amalgamation of FIG. 7.1.1.2-1 Initial Configuration for MBS Session without PCC and FIG. 7.3.1-1 MBS Session Establishment for Broadcast from 3GPP TS 23.247 (V17.0.0, 2021-09). It is noted that modifications to the conventional steps from the 3GPP specification are provided according to the example embodiment described hereinbelow. Some of the steps in FIG. 6 may appear unchanged from the TS 23.247 specification (one modification appearing in FIG. 6 is in the arrow box between steps 18 and 19) due to the fact that the FIG. is merely a high level representation of the signal flow, without expressly representing all of the details. However, the modifications to the conventional process are described in the following text, including particularly significant modifications to behavior that are implemented to locally breakout an MBS session to a non-3GPP access supporting IEEE 802.11bc. Hence, the following description includes a summary of the standard steps as defined in the 3GPP TS 23.247, together with the extensions included in accordance with the present embodiment.

Steps 1 to 6 of FIG. 6 are optional and applicable if TMGI is used as MBS Session ID and required to be pre-allocated. This procedure may be used to allocate a TMGI to the MBS session.

In Step 7, the AF may perform a Service Announcement towards the WTRUs. The AF informs the WTRUs about MBS Session information with MBS Session ID, e.g., TMGI, source specific multicast address, and possibly other information, (such as, MBS service area, session description information, etc.). Step 7 considers a generic MBS service which is being setup across the 3GPP network. This MBS service may potentially require the involvement of several UPFs. Therefore, at the moment of Step 7, there will be RAN parts that may receive the advertisement while others may not. In addition, in Step 18 (to be discussed in more detail below), it is assumed the transport for the MBS is already established and then the NG-RAN may receive the advertisement and may relay it to the WTRUs. It is important to note that the WTRU shown in the FIG. has not yet established a PDU session, so it cannot yet receive an MBS. The MBS service area information can comprise a Cell ID list, a TAI list, geographical area information, or civic address information. Amongst them, Cell ID list and TAI list may be used only by AFs who reside in a trusted domain, and when the AFs are aware of such information. The MBS Service area may also include IEEE 802.11bc accesses, identified, for example, through a TWID (Trusted Wireless ID) or a Registration Area (RA) allocated to a Non-3GPP access.

This new inclusion into the MBS Service area serves as a way to indicate that EBCS APs can be used for the transmission of the service. This MBS Service Information Element in the Context is used to actually store the current areas where the content is being transmitted. With the current definition of the element, a non-3GPP network cannot be used. The information may come from multiple sources, such as the AF, which indicates the area where the service needs to be broadcasted, or it may come from the SMF (the SMF may obtain it from UDR/UDM or PCF) and this may be configured in the network. Finally, please note this element also may be present at the AMF, and thus may serve as a variable indicating where the service is being transmitted.

In 3GPP 23.247, it is assumed the MBS Service area is sent by the AF in step 7.

The WTRU should be aware whether the service is a broadcast service or a multicast service in order to decide whether a JOIN operation is to be performed. This information is obtained by listening to advertisement messages from the AF (step 18).

Steps 8 to 17 correspond to the creation of the MBS Session context at the MB-SMF, the selection of the MB-UPF, and the creation of the MBS Session context at the MB-UPF.

Step 18 shows the periodic advertisements that the AF performs. As the path to the WTRU is built, advertisements may arrive to the WTRU, indicating the different relevant information, such as the nature of the service (i.e., multicast or broadcast).

At this point, the WTRU requests a PDU session establishment (arrow box between steps 18 and 19). This procedure contains the information on the ATSSS capabilities and indicates that the PDU session to be created may later be upgraded to use Multiple Accesses. To cover the aspects of steering to a broadcast network, example embodiments the extension (indicated in bold in the arrow box between steps 18 and 19) of the steering modes as defined in 3GPP TS 23.501 (v17.2.0). Current ATSSS supports four modes for steering, namely: Active-Standby, Smallest Delay, Load Balancing, and Priority-based.

A fifth steering mode may be added, namely: Multicast, where multicast mode is used to steer a service data flow to the access that supports specialized broadcast/multicast transmission enhancements, such as IEEE 802.11bc or DVB networks. Broadcast offload is only applicable to UDP traffic and ATSSS-LL (Low Layer).

The definition of this new steering mode may have implications for other structures as defined in 3GPP. Specifically, the 5GSM capability IE (as defined in Table 9.11.4.1.1 of 3GPP TS 24.501 (v17.5.0) may be modified to include an “ATSSS Low-Layer functionality with only broadcast breakdown mode supported” as shown in Table 3 below:

TABLE 3
Modification to Table 9.11.4.1.1 (3GPP TS 24.501 V17.5.0)

Supported ATSSS steering functionalities and steering modes (ATSSS-ST) (octet 3, bits 4 to 7)
These bits indicate the 5GSM capability of ATSSS steering functionalities and steering modes
0 0 0 0 ATSSS not supported
0 0 0 1 ATSSS Low-Layer functionality with any steering mode supported
0 0 1 0 MPTCP functionality with any steering mode and ATSSS-LL functionality with only
active-standby steering mode supported
0 0 1 1 MPTCP functionality with any steering mode and ATSSS-LL functionality with any
steering mode supported All other values are reserved.
0 1 0 0 ATSSS Low-Layer functionality with only broadcast breakdown mode supported.

The PDU Session Establishment Request in the arrow box between steps 18 and 19 may include the ATSS Low-Layer functionality with only the Multicast breakdown mode supported bit set in the 5GSM capability IE.

Step 19 associates the PDU connection established in the procedure represented by the arrow box between steps 18 and 19 to the MBS traffic. Steps 20 to 24 correspond to the completion of the session setup and the preparation of the radio bearer.

Once the configuration of the network is completed, the WTRU can join the broadcast stream by issuing an Internet Group Management Protocol/Multicast Listener Discovery (IGMP/MLD) join (step 25) and complete the session join (steps 26-30).

Once the WTRU has joined the MBS service (e.g., as shown in FIG. 6), FIG. 7 shows a procedure to breakout the MBS stream to the IEEE 802.11bc network may be implemented such as shown in FIG. 7. Note that, at this point, the MBS is being delivered over the 3GPP side. Some of the more significant new or modified steps are emphasized in the text below by underlining.

Referring to FIG. 7, first, in step 1, the known procedures for the WTRU to connect to a non-3GPP domain and establish a secure N1 transport are performed. The procedures presented in FIG. 7 do not assume either a trusted or untrusted non-3GPP domain, but is applicable to both scenarios.

In step 2, the WTRU requests establishment of a new PDU session over the non-3GPP access. In order to use ATSSS features, the PDU Session Establishment Request incorporates information on the ATSSS capabilities in the 5GSM capability IE with the modifications indicated above. This message may also include the information needed to associate the PDU connection associated with the MBS traffic with this new PDU session establishment. The information that is needed to associate the PDU Session with the MBS traffic may be an MBS Session ID, e.g., a TMGI.

Alternatively, a first PDU Session may have been established over 3GPP access prior to step 2. This first PDU Session may have been associated with the MBS Session because the MBS Session ID was included in the PDU Session Establishment Request. In step 2, the new PDU session over the non-3GPP access may be associated with the MBS Session by including the PDU Session ID of the first PDU Session in the PDU Session Establishment Request of step 2.

In step 3, after receiving the PDU Session Establishment Request, the AMF will select the SMF based on the identifier (i.e., MBS Session ID or PDU Session ID) carried in step 2, indicating the PDU connection carrying the MBS traffic in the 3GPP access. Based on that, the SMF in charge of transporting the MBS traffic will be contacted as well as the MB-SMF (steps 4-6).

Steps 4 to 9 correspond to the standard mechanisms for the SMF to gather the required information to process the session, authorization, and PCF selection.

In steps 10 and 11, the SMF will select the UPF based on the non-3GPP location and the MBS traffic stream (step 10) and will configure the transport mechanism needed to carry the traffic towards the non-3GPP domain (Step 11).

Through the messages in steps 12 and 13, the SMF may push the available information regarding the MBS service (as per the MBS Context in Tables 1 and 2) toward the AMF (step 12), which in turn, may forward this information to the non-3GPP domain (the MBS_EBCS_Controller) (step 13). This message carries information to create an IEEE 802.11bc configuration for the EBCS. This information may be complemented once a service advertisement from the AF is received by the MBS_EBCS_Controller. The SMF uses the PDU Session ID or MBS Session ID (e.g., TMGI) from step 2 to determine what information to forward to the AMF in step 12.

With this information, the MBS_EBCS_Controller configures the EBCS domain (step 14) and EBCS service information, in step 15, starts to be transmitted in the EBCS network via IEEE 802.11bc mechanisms (e.g., EBCS Info frame and EBCS ANQP-element available), including the EBCS Configuration (e.g., configure the services to be advertised in the EBCS Info frame and their security parameters), and the EBCS service advertisement (step 16).

Once the EBCS domain has been configured, the WTRU is informed by answering the PDU Session Establishment (step 17).

In step 18, the MBS_EBCS_Controller may join the MBS on behalf of the WTRUs connected to the EBCS domain. FIG. 7 shows the MBS_EBCS_Controller sending the multicast join primitive, but this alternately may be done by the WTRU, through the newly established PDU session.

In step 19, the MBS_EBCS_Controller forwards the PDU session establishment accept message to the AMF.

In the case of using ATSSS (as in this embodiment), the data plane traffic of the MBS may be transmitted using IEEE 802.11bc by the application of traffic steering rules at the IEEE 802.11 network. These rules may be installed by the MBS_EBCS_Controller.

Step 20 includes the known procedures in order to update the N4 sessions that transport the traffic towards the non-3GPP network. The exact messages depend on the choice of transport mechanism decided for the MBS session and are outside of the scope of this disclosure.

Service Advertisement Integration Between 3GPP MBS Domain and IEEE 802.11bc for Broadcast Traffic (without ATSSS Support)

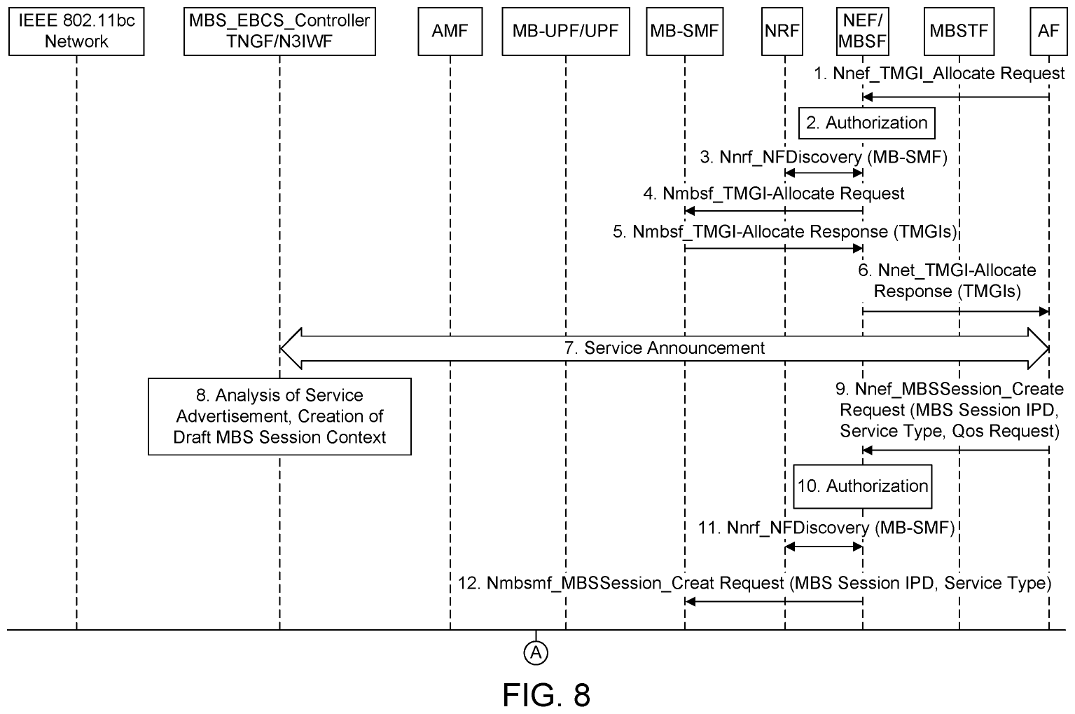

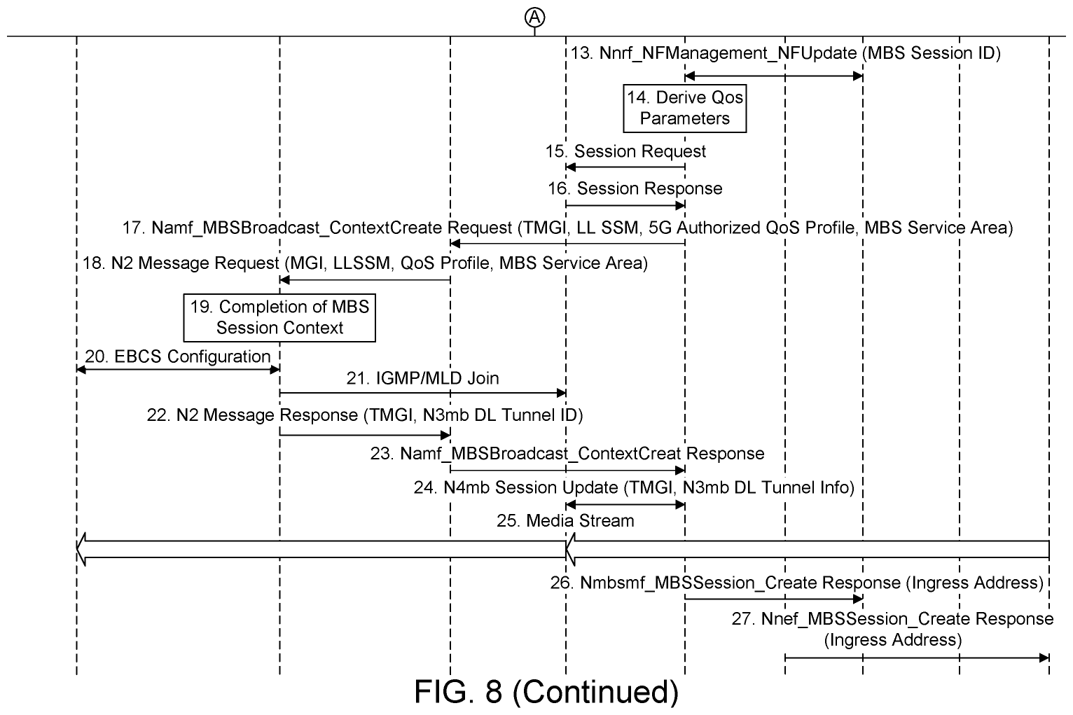

MBS and IEEE 802.11bc use completely different mechanisms for the advertisement of services to the users. MBS allows the source of the MBS service to send advertisement messages (e.g., using SDP) to inform users of the MBS sessions about to start. IEEE 802.11bc requires pre-registration of multicast/broadcast services before they are allowed to be transmitted at the air interface. FIG. 8 is a signal flow diagram presenting the different steps as extended from 3GPP TS 23.247 (V17.0.0, 2021-09) for the initial configuration and setup process of a broadcast MBS stream being transmitted over IEEE 802.11bc networks in accordance with an embodiment. This diagram shows the MBS_EBCS_Controller as a functionality of the TNGF/N2IWF. In alternate embodiments, a similar process may be used if the MBS_EBCS_Controller forms part of the N3IWF or any other function acting as gateway of a non-3GPP network connected to the 3GPP infrastructure.

FIG. 8 is an amalgamation of FIGS. 7.1.1.2-1 Initial Configuration for MBS Session without PCC and 7.3.1-1 MBS Session Establishment for Broadcast of 3GPP TS 23.247 (V17.0.0, 2021-09). The following includes a summary of the steps as defined in the 3GPP TS 23.247, together with the extensions, changes in behavior and/or new procedures included in accordance with the present embodiment.

Steps 1 to 6 of FIG. 8 are optional and only applicable if TMGI is used as MBS Session ID and required to be pre-allocated. This procedure is used to allocate a TMGI to the MBS session.

In Step 7, the AF may perform a Service Announcement towards the WTRUs.

The AF informs the WTRUs about MBS Session information with MBS Session ID, e.g., TMGI, source specific multicast address, and possibly other information (such as MBS service area, session description information, etc.).

The MBS service area information can be a Cell ID list, a Tracking Area Identity (TAI list), geographical area information, or civic address information. Amongst them, Cell ID list and TAI list shall only be used by AFs who reside in a trusted domain, and when the AFs are aware of such information. The MBS Service area may include IEEE 802.11bc accesses, which may be identified, for example, through a TWID. The information provided from the AF is needed to understand if the service is broadcast.

Step 8 corresponds to the case when the MBS Service area includes IEEE 802.11bc networks. In this case, the service announcement (which may be performed through Session Initiation Protocol (SIP) or other mechanisms such as the ones specified in 3GPP TS 26.346) is received by the MBS_EBCS_Controller, which uses the information within the service description to build a draft MBS Session Context (or a separated structure containing the required EBCS parameters) including the relevant information provided by the service announcement. This information is not yet forwarded to the IEEE 802.11bc domain, since, at this point, the traffic cannot be started, and, therefore announcement within the IEEE 802.11bc domain cannot start.

Steps 9 to 16 correspond to the creation of the MBS Session context at the MB-SMF, the selection of the MB-UPF, and the creation of the MBS Session context at the MB-UPF.

After the MB-UPF has created the MBS Session context, the MB-SMF chooses the AMF to interact with the IEEE 802.11bc enabled network. The AMF installs the MBS Session Context (step 17, in this case a Broadcast Context as defined in Table 1) upon triggering from the SMF and, using the N3 interface, sends the required information for completing the MBS Session Context to the MBS_EBCS_Controller (step 18).

At this point, the MBS_EBCS_Controller is able to complete the MBS Session context and push the MBS stream configuration in the IEEE 802.11bc network, pre-configuring the advertisement and filtering so that the traffic will be broadcast in the network (steps 19 to 20). The messages identified in steps 19 to 21 will use a newly defined interface able to configure the IEEE 802.11bc advertisement and filtering mechanisms.

Once the IEEE 802.11bc network is completed, the MBS_EBCS_Controller is able to join the broadcast stream by issuing an IGMP/MLD join (step 21) and completing the session join (steps 22-25).

Note that, in the embodiment of FIG. 8, the Join/MLD is sent by the MBS_EBCS_Controller. However, since this is a functional element, the Join/MLD may be sent by any other function belonging to the TNGF, N3IWF, or similar function used to connect IEEE 802.11 to 3GPP networks.

In this case, since it is an MBS broadcast transmission, the IEEE 802.11bc network will advertise the configure service and transmit over the air the stream traffic even if no STA is associated to the IEEE 802.11bc AP or no request to start the traffic is received.

Steps 26 and 27 are used to indicate to the AF, through the NEF/MBSF, the completion of the MBS session setup.

Service Advertisement Integration Between 3GPP MBS Domain and IEEE 802.11bc for Multicast Traffic (without ATSSS Support)

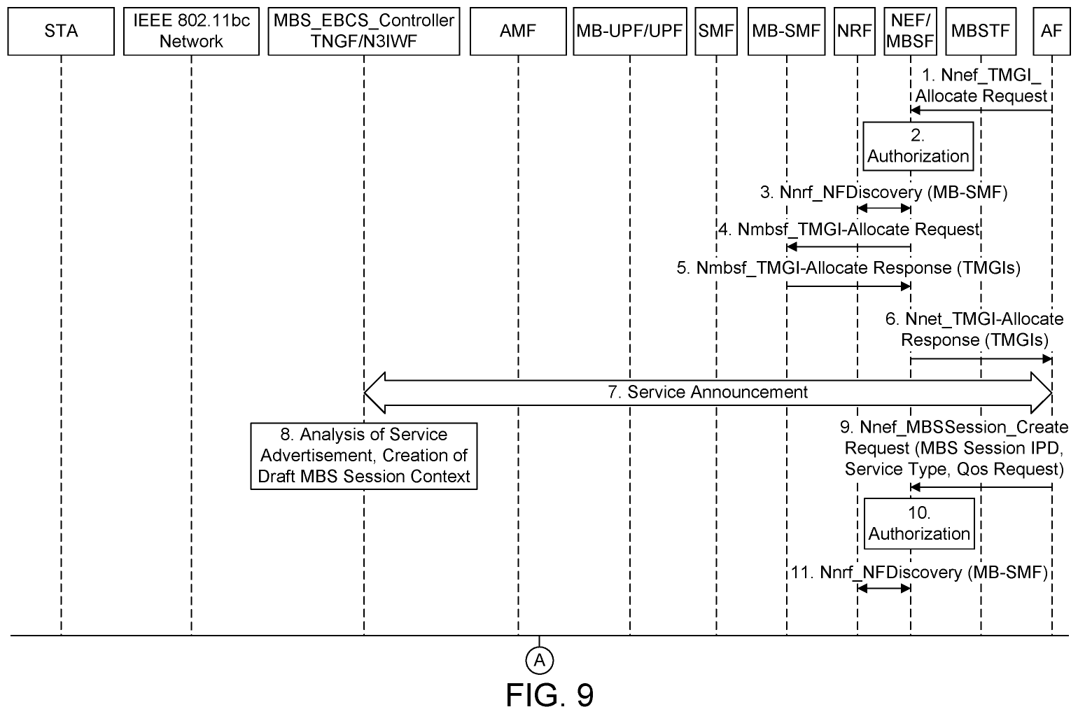

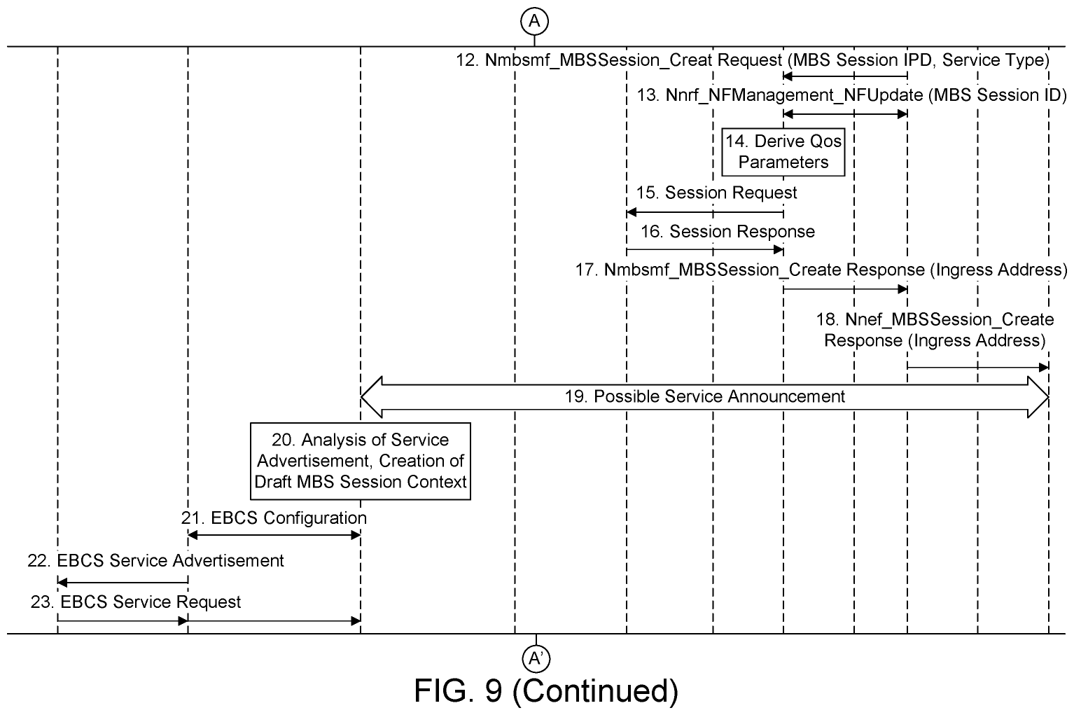

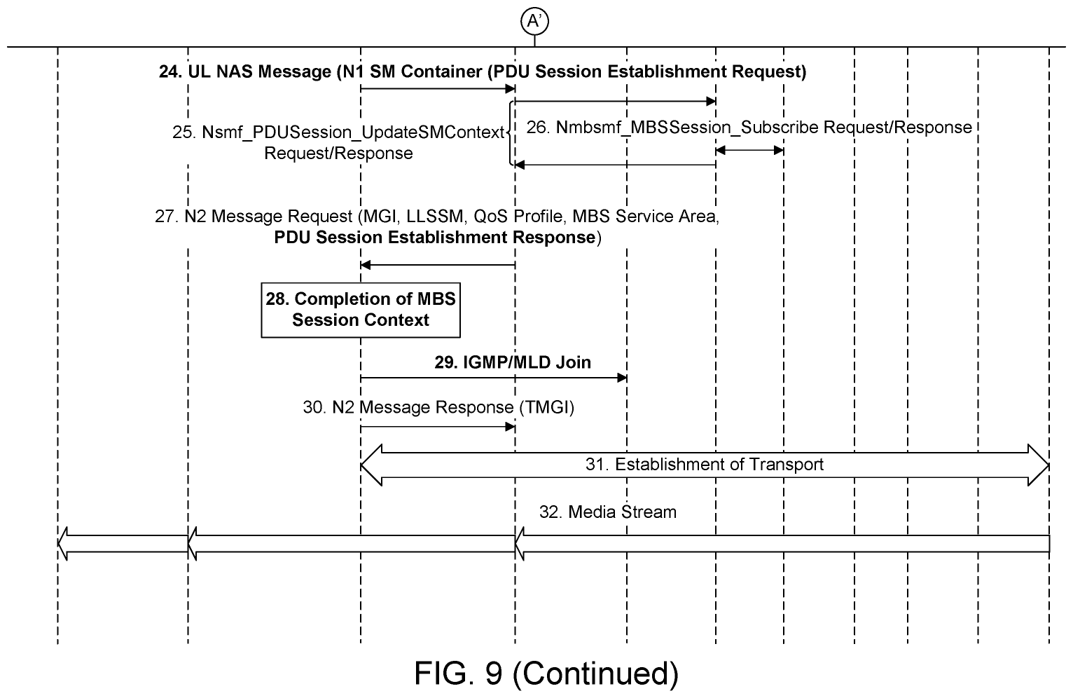

FIG. 9 shows the message sequence of the starting of a multicast service requiring request from the IEEE 802.11bc side. In this case, the MBS_EBCS_Controller WTRU part plays a central role since it performs the MBS request of the service on behalf of the STAs at the IEEE 802.11bc side.

FIG. 9 includes different steps which are taken from FIG. 7.1.1.2-1—Initial Configuration for MBS Session without PCC and FIG. 7.2.1.3-1: PDU Session modification for WTRU joining multicast session of 3GPP TS 23.247 V17.0.0 (2021-09).

Up to step 16, the message sequence for multicast shown in FIG. 9 is substantively the same as for broadcast (FIG. 8). After setting the session up in the MB-UPF, the differences start to appear. First, in this case, steps 17 and 18 indicate to the AF the completion of the MBS session setup towards the MB-UPF. This step is needed since no MBS transmission will be performed unless some WTRU requests the multicast stream. For a WTRU to join a multicast session, it needs to know at least the MBS Session ID or multicast group. This information can partly be obtained from the service advertisement in step 19.

In Step 20, the MBS_EBCS_Controller intercepts the service advertisement message describing the MBS service to be provided and analyzes it. The service advertisement may include information such as IP multicast address used, protocol, port or service description among others. This information is used to complete the MBS Context for this service stored at the MBS_EBCS_Controller.

In step 21, the information gathered from the service announcement (step 20) is configured in the IEEE 802.11bc domain. In step 22, the service starts to be advertised in the 802.11bc network via its introduction in the Enhanced Broadcast Services ANQP-element and EBCS Info frames (as per IEEE 802.11bc/D2.0, step 22).

In step 23, a STA requests he starting of the MBS service by issuing an EBCS request frame or Enhanced Broadcast Service Request ANQP-element (as per IEEE 802.11bc/D2.0).

Upon receiving the service request frame, the IEEE 802.11bc network will notify the MBS_EBCS_Controller of the need to request the service to the 5G network. At this point, the MBS_EBCS_Controller will issue the signaling needed to request the service and join the multicast stream (steps 24 to 30).

A key feature of steps 24 and 27 is the fact that the MBS_EBCS_Controller may behave as an WTRU on behalf of the nodes in the non-3GPP domain, requesting a PDU Session Establishment.

After this process, the network will set up a transport between the gateway to the IEEE 802.11bc network (step 31), and the multicast stream will start (step 32).

### MBS Session Activation

In some example embodiments, the WTRU may receive a request over a first access to receive MBS data over a second access. The first access may be a 3GPP or a non-3GPP access network and the second access may be the other of a 3GPP or a non-3GPP access network. The request may include the information that is necessary to receive the service (i.e., an MBS Session ID or a PDU Session ID that is associated with an MBS Session ID).

As described in 3GPP TS 23.247, clause 7.2.5.2, an AF may trigger the MBS Session Activation procedure or an MB-UPF may trigger the MBS Session Activation procedure when it receives multicast data.

When MBS Session Activation is triggered, the MB-SMF sends Nmbsmf_MBSSession_ContextStatusNotify (MBS Session ID, multicast session activated) to the SMF(s). The SMF will then invoke the Namf_MT_EnableGroupReachability Request (List of WTRUs, [PDU Session ID of the associated PDU Sessions], TMGI, [WTRU reachability Notification Address]) for the AMF(s) that serve the WTRUs that are part of the service.

For each WTRU that is part of the service, the AMF will then determine the WTRU's CM state for both 3GPP and non-3GPP access. The AMF may then take the following actions.

If the WTRU is in the CM-CONNECTED state in 3GPP access, the AMF may send the WTRU a NAS Notification containing the MBS Session ID and non-3GPP Access Type that the WTRU should use to receive the MBS Session. The NAS Notification may be sent via 3GPP access and trigger the WTRU to move from the CM-IDLE state to the CM-CONNECTED state in non-3GPP access. Moving to the CM-CONNECTED state in non-3GPP means that the WTRU is triggered to send a Service Request over non-3GPP access, and the service request may include an MBS Session ID or a PDU Session ID that is associated with an MBS Session ID.

If the WTRU is in CM-IDLE state for 3GPP Access, the AMF may send a NAS Notification containing the MBS Session ID and 3GPP Access Type that the WTRU should use to receive the MBS Session. The NAS Notification may be sent via non-3GPP access and trigger the WTRU to move from the CM-IDLE state to the CM-CONNECTED state in 3GPP access. Moving to the CM-CONNECTED state in 3GPP means that the WTRU is triggered to send a Service Request over 3GPP access, and the service request may include an MBS Session ID or a PDU Session ID that is associated with an MBS Session ID.

### Example Method

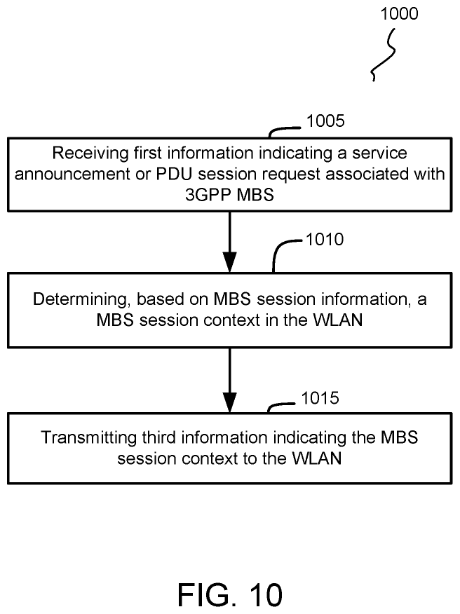

FIG. 10 is an example flow diagram illustrating an example method 1000 for interfacing between a 3GPP network and a wireless local area network (LAN), according to some example embodiments. The example method of FIG. 10 and accompanying disclosures herein may be considered a generalization or synthetization of the various disclosures discussed above. For convenience and simplicity of exposition, the example of FIG. 10 may be described with reference to the architecture of the architecture described with respect to FIG. 5. However, the example method depicted in FIG. 10 may be carried out using different architectures as well. According to some embodiments, the method of FIG. 10 may be implemented by a network entity, such as the MBS/EBCS Controller 501 described in the foregoing. It is noted that the method and/or blocks of FIG. 10 may be modified to include, or to be replaced by, any one or more of the procedures or blocks discussed elsewhere herein, such as those illustrated in one or more of the signaling diagrams of FIGS. 6-9. As such, one of ordinary skill in the art would understand that FIG. 10 is provided as one example and modifications thereto are possible while remaining within the scope of certain example embodiments.

As illustrated in the example of FIG. 10, the method 1000 may include, at 1005, receiving, from the 3GPP network, first information that may indicate or include a service announcement or a protocol data unit (PDU) session request associated with 3GPP multicast/broadcast services (MBS). The first information may include or indicate MBS session information.

In some embodiments, the PDU session request may indicate or may include access traffic steering, switching and splitting (ATSSS) capabilities, as discussed elsewhere herein. According to an embodiment, the first information may be received in a non-access stratum (NAS) notification, which may indicate the MBS session identifier and/or non-3GPP access type that the WTRUs can (e.g., should) use to receive the MBS session.

In an embodiment, the method 1000 may include, at 1010, determining, based on the MBS session information, a MBS session context in the wireless LAN. The MBS session context may include second information used (e.g., to be used) for transmission of the MBS over the wireless LAN. According to one embodiment, the wireless LAN may be a 802.11bc network. However, in further example embodiments, the wireless LAN may be another type of LAN.

According to an embodiment, the method 1000 may include, at 1015, transmitting third information indicating the MBS session context (e.g., including the second information) to the wireless LAN for distribution to Wireless Transmit Units (WTRUs) in the wireless LAN.

In some example embodiments, as outlined in the foregoing (e.g., as shown in Table 1 and/or Table 2), the second information (and/or the MBS session context) may include or indicate at least any one or more of: (1) a list of wireless LAN networks in the MBS service area, (2) an indication of an enhanced broadcast service (EBCS) state, (3) a content identifier, (4) related content identifiers, (5) access point identifiers, (6) an indication of a content authentication algorithm, (7) an indication of a time of next transmission, (8) an indication of a protocol and port used for the transmission of the MBS, (9) an indication of whether a broadcasted EBCS requires association to an access point of the wireless LAN, and/or (10) quality of service (QOS) information.

According to an example embodiment, as discussed in more detail above, the MBS session information may include or may indicate any one or more of: (1) a MBS session identifier, (2) a temporary mobile group identity (TMGI), (3) a MBS service area, and/or (4) session description information.

In some embodiments, the method 1000 may include joining the MBS on behalf of the WTRUs in the wireless LAN. For instance, the joining may include transmitting, to the 3GPP network, an Internet Group Management Protocol/Multicast Listener Discovery (IGMP/MLD) join message corresponding to the MBS.

According to certain example embodiments, in case of multicast transmission, the method 1000 may include receiving a trigger, from an EBCS domain, to start a multicast stream associated with the MBS.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, MME, EPC, AMF, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, [ ] 6 or means-plus-function claim format, and any claim without the terms “means for” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

### REFERENCES

[1] https://mentor.ieee.org/802.11/dcn/19/11-19-0151-05-00bc-802-11bc-functional-requirements-document.doc
[2] https://mentor.ieee.org/802.11/dcn/19/11-19-0268-05-00bc-tgbc-use-case-document.pptx
[3] Technical Report on Interworking between 3GPP 5G network and WLAN. https://mentor.ieee.org/802.11/dcn/20/11-20-0013-17-AANI-technical-report-on-interworking-between-3gpp-5g-network-wlan.docx
[4] TS 23.247 (v17.0.0, 2021-09). 3rd Generation Partnership Project; Technical Specification Group Services and System Aspects; Architectural enhancements for 5G multicast-broadcast services; Stage 2 (Release 17).
[5] TS 23.502 (v17.2.0, 2021-09). 3rd Generation Partnership Project; Technical Specification Group Services and System Aspects; System architecture for the 5G System (5GS); Stage 2 (Release 17
[6] TS 24.502 (v17.4.0, 2021-09). 3rd Generation Partnership Project; Technical Specification Group Core Network and Terminals; Access to the 3GPP 5G Core Network (5GCN) via non-3GPP access networks
[7] TS 23.501 (v17.2.0, 2021-09). 3rd Generation Partnership Project; Technical Specification Group Services and System Aspects; System architecture for the 5G System (5GS); Stage 2 (Release 17
[8] TS 24.501 (v17.5.0, 2021-12). 3rd Generation Partnership Project; Technical Specification Group Core Network and Terminals; Non-Access-Stratum (NAS) protocol for 5G System (5GS); Stage 3; (Release 17)
[9] TS 26.346 (v16.9.1, 2021-05). 3rd Generation Partnership Project; Technical Specification Group Services and System Aspects; Multimedia Broadcast/Multicast Service (MBMS); Protocols and codecs. (Release 16)
[10] IEEE 802.11bc/D2.0. Draft Standard for Information technology-Telecommunications and information exchange between systems Local and metropolitan area networks-Specific requirements. Part 11: Wireless LAN Medium Access Control (MAC) and Physical Layer (PHY) Specifications. Amendment 5: Enhanced Broadcast Services
[11] TS 23.468 (v16.0.0, 2020-07). 3rd Generation Partnership Project; Technical Specification Group Services and System Aspects; Group Communication System Enablers for LTE (GCSE_LTE) Stage 2. (Release 16)

What is claimed is:

1. An apparatus configured to interface between a 3GPP network and a wireless local area network (LAN), the apparatus comprising:
circuitry including any of a processor, memory, transmitter and receiver, the circuitry configured to:
receive, from the 3GPP network, first information indicating a service announcement or a protocol data unit (PDU) session request associated with 3GPP multicast/broadcast services (MBS), the first information comprising MBS session information;
determine, based on the MBS session information, a MBS session context in the wireless LAN, the MBS session context comprising second information used for transmission of the MBS over the wireless LAN; and
transmit third information indicating the MBS session context to the wireless LAN for distribution to Wireless Transmit Units (WTRUs) in the wireless LAN.

2. The apparatus of claim 1, wherein the wireless LAN comprises a 802.11bc network.

3. The apparatus of any of claim 1 or 2, wherein the PDU session request indicates access traffic steering, switching and splitting (ATSSS) capabilities.

4. The apparatus of any of claims 1-3, wherein the second information comprises any of: (1) a list of wireless LAN networks in the MBS service area, (2) an indication of an enhanced broadcast service (EBCS) state, (3) a content identifier, (4) related content identifiers, (5) access point identifiers, (6) an indication of a content authentication algorithm, (7) an indication of a time of next transmission, (8) an indication of a protocol and port used for the transmission of the MBS, (9) an indication of whether a broadcasted EBCS requires association to an access point of the wireless LAN, and/or (10) quality of service (QOS) information.

5. The apparatus of any of claims 1-4, wherein the MBS session information comprises any of: (1) MBS session identifier, (2) temporary mobile group identity (TMGI), (3) MBS service area, and/or (4) session description information.

6. The apparatus of any of claims 1-5, wherein the first information is received in a non-access stratum (NAS) notification indicating the MBS session identifier and non-3GPP access type that the WTRUs should use to receive the MBS session.

7. The apparatus of any of claims 1-6, wherein the circuitry is configured to:
join the MBS on behalf of the WTRUs in the wireless LAN

8. The apparatus of claim 7, wherein the circuitry is configured to:
transmit an Internet Group Management Protocol/Multicast Listener Discovery (IGMP/MLD) join message corresponding to the MBS to the 3GPP network.

9. The apparatus of any of claims 1-8, wherein, in case of multicast transmission, the circuitry is configured to receive a trigger, from an EBCS domain, to start a multicast stream associated with the MBS.

10. A method for interfacing between a 3GPP network and a wireless local area network (LAN), the method comprising:
receiving, from the 3GPP network, first information indicating a service announcement or a protocol data unit (PDU) session request associated with 3GPP multicast/broadcast services (MBS), the first information comprising MBS session information;
determining, based on the MBS session information, a MBS session context in the wireless LAN, the MBS session context comprising second information used for transmission of the MBS over the wireless LAN; and
transmitting third information indicating the MBS session context to the wireless LAN for distribution to Wireless Transmit Units (WTRUs) in the wireless LAN.

11. The method of claim 1, wherein the wireless LAN comprises a 802.11bc network.

12. The method of any of claim 10 or 11, wherein the PDU session request indicates access traffic steering, switching and splitting (ATSSS) capabilities.

13. The method of any of claims 10-12, wherein the second information comprises any of: (1) a list of wireless LAN networks in the MBS service area, (2) an indication of an enhanced broadcast service (EBCS) state, (3) a content identifier, (4) related content identifiers, (5) access point identifiers, (6) an indication of a content authentication algorithm, (7) an indication of a time of next transmission, (8) an indication of a protocol and port used for the transmission of the MBS, (9) an indication of whether a broadcasted EBCS requires association to an access point of the wireless LAN, and/or (10) quality of service (QOS) information.

14. The method of any of claims 10-13, wherein the MBS session information comprises any of: (1) MBS session identifier, (2) temporary mobile group identity (TMGI), (3) MBS service area, and/or (4) session description information.

15. The method of any of claims 10-14, wherein the first information is received in a non-access stratum (NAS) notification indicating the MBS session identifier and non-3GPP access type that the WTRUs should use to receive the MBS session.

16. The method of any of claims 10-15, comprising:
joining the MBS on behalf of the WTRUs in the wireless LAN

17. The method of claim 16, wherein the joining comprises transmitting an Internet Group Management Protocol/Multicast Listener Discovery (IGMP/MLD) join message corresponding to the MBS to the 3GPP network.

18. The method of any of claims 10-17, wherein, in case of multicast transmission, the method comprises receiving a trigger, from an EBCS domain, to start a multicast stream associated with the MBS.
